(19) United States
(12) Patent Application Publication
(10) Pub. No.: US 2014/0337475 A1
(43) Pub. Date: Nov. 13, 2014

(54) ASYNCHRONOUS SOCIAL CONSUMPTION

(71) Applicant: William P. Tolany, Austin, TX (US)

(72) Inventor: William P. Tolany, Austin, TX (US)

(21) Appl. No.: 14/274,459

(22) Filed: May 9, 2014

Related U.S. Application Data
(60) Provisional application No. 61/821,339, filed on May 9, 2013.

(51) Int. Cl. H04L 29/06; G06F 3/0484

(52) U.S. Cl. CPC H04L 65/60; G06F 3/04842
USPC 709/218; 715/753

(57) ABSTRACT

A method of displaying previously recorded and stored primary media content, such as a movie, program, or application, is provided with simultaneous display of previously transmitted secondary content, such as social media.

### CROSS-REFERENCE TO RELATED APPLICATIONS

This application is a U.S. non-provisional application claiming priority and benefit of prior-filed U.S. Provisional Application No. 61/821,339, filed May 9, 2013.

### FIELD

The present disclosure relates generally to information consumption and, more particularly, to the consumption of thematic information intended to enhance the enjoyment of a specific experience.

### BACKGROUND

Two significant and competing trends are related to the present disclosure. The first trend is the significant rise in the amount of social media content. Regardless of the form and subject matter of this social content, it has become increasingly unwieldy for individuals to manage and consume its growing volume. In addition, the social media content accessed by individuals is typically organized around the creators of that content rather than the content theme or subject matter itself. Current social media content also tends to be ephemeral, with the majority of consumption of specific social media content occurring soon after its publication. Individuals do not possess convenient access to historical thematic social content.

The second related trend is the increasing prevalence of asynchronous content consumption unrelated to social media. New technologies have enabled individuals to time-shift content consumption to fit their own personal schedule. Content is also consumed across geographies at different times either due to time zone differences or general availability of the specific experience. Furthermore, content creators now also have enhanced distribution methods that remove time restrictions on when their creations must be consumed. These enhanced distribution methods enable individuals to consume content whenever it is convenient for them, greatly increasing the likelihood of asynchronous consumption.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic layout of an exemplary display according to a method of the disclosure;

FIG. 2 is an exemplary display of Primary and Secondary Content according to aspects of the disclosure; and

FIG. 3 is an exemplary display of Primary and Secondary Content, and User Content Input prompts according to aspects of the disclosure.

FIG. 4 is an exemplary display of Customization Preferences and prompts according to aspects of the disclosure.

FIG. 5 is a schematic illustrating an aggregated view of activity related to the method of this disclosure.

FIG. 6 is a schematic representation of a database and data stored therein according to an aspect of the disclosure.

FIG. 7 is an exemplary computer network according to an aspect of the disclosure.

FIG. 8 is a schematic of an exemplary computerized architecture according to an aspect of the disclosure.

FIG. 9 is a flow chart according to an aspect of the invention.

### DETAILED DESCRIPTION OF CERTAIN EMBODIMENTS

The present disclosure is described with reference to the figures of the drawing showing one or more examples of how the inventions can be made and used. In the drawing, reference characters are used throughout the several views to indicate like or corresponding parts. In the description which follows, like or corresponding parts are marked throughout with the same reference numerals.

### Computer/Computerized System

The system, methods, and other embodiments according to the present disclosure include computerized systems requiring the performance of one or more methods or steps performed on or in association with one or more computer. A computer is a programmable machine having two principal characteristics, namely, it responds to a set of instructions in a well-defined manner and can execute a pre-recorded list of instructions (e.g., a program). A computer according to the present disclosure is a device with a processor and a memory. For purposes of this disclosure, a computer includes a server, a personal computer, (i.e., desktop computer, laptop computer, netbook), a mobile communications device (e.g., “smart” phone), and devices providing functionality through internal components or connection to an external computer, server, or global communications network (such as the internet) to take direction from or engage in processes which are then delivered to other system components. Those of skill in the art recognize that other devices, alone or in conjunction with an architecture associated with a system, can provide a computerized environment for carrying out the methods disclosed herein. The method aspects of the disclosure are computer implemented and, more particularly, at least one step is carried out using a computer.

General-purpose computers include hardware components. A memory, memory device, or memory storage device enables a computer to store data and programs and may be referred to, in part or as a whole, as a database. Common memory storage devices include disk drives, tape drives, thumb drives, and others known in the art. An input device can be a keyboard, mouse, hand-held controller, remote controller, a touchscreen, and other input devices known in the art. The input device is the conduit through which data and instructions enter a computer. An output device is a display screen, printer, or other device letting the user sense what the computer has accomplished, is accomplishing, or is expected to accomplish. A central processing unit (CPU) is the “brains” of the computer and executes instructions and performs calculations. The CPU can be a micro-processor, processor, one or more printed circuit boards (PCBs). These and other components make it possible for computer components to work together or in conjunction with external devices and systems, for example, a bus to transmit data within the computer, ports for connectivity to external devices or data transmission systems (such as the internet), wireless transmitters, read and read-write devices, etc., such as are known in the art.

### Server

A server is a computer or device on a network that manages network resources. There are many different types of servers, including remote, live and network access servers, data servers, member servers, staging servers, etc. A server can be hardware and/or software that manages access to a centralized resource or service in a network. For purposes of this disclosure, the term “server” also includes “virtual servers” which can be hosted on actual servers.

### Network

A computer network or data network is a communications network allowing computers to exchange data, with networked devices passing data to each other on data connections. Network devices that originate, route, and terminate data are called nodes. The connections (links) between nodes are established using wire or wireless media. Nodes can include hosts, such as PCs, phones, servers, and networking hardware. Devices are networked together when one device is able to exchange information with the other device whether or not they have a direct connection to each other. Computer networks support applications such as access to the World Wide Web (WWW) or internet, shared use of application and storage servers, printers, and use of email and instant messaging applications. Computer networks differ in the physical media to transmit signals, protocols to organize network traffic, network size, topology, and organizational intent.

### Gateway

A (control) gateway is a network node that acts as an entrance to another network. In homes, the gateway is the ISP (internet service provider) that connects the user to the internet. In enterprises, the gateway node often acts as proxy server and firewall. The gateway is also associated with a router, which uses headers and forwarding tables to determine where packets are sent, and a switch, which provides the actual path for the packet in and out of the gateway.

### Router

A router forwards data packets along networks and is connected to at least two networks, commonly two LANs, WANs, or a LAN and its ISP's network. Routers are located at “gateways,” the places where two or more networks connect. Routers use headers and forwarding tables to determine paths for forwarding packets and use protocols to communicate with each other to configure a route between hosts.

### Database

One or more databases are used for storing information and data. The information stored on a database can, for example, be related to a user, content source, primary or secondary content provider, third-party content source, a content host, etc. One of ordinary skill in the art appreciates that “a database” can be a plurality of databases, each of which can be linked to one another, accessible by a user via a user interface, stored on a computer readable medium or a memory of a computer (e.g., PC, server, etc.), and accessed by users via global communications networks (e.g., the internet) which may be linked using satellites, wired technologies, or wireless technologies.

### Description

The two trends discussed above are at odds. The volume and nature of social content consumption means it is driven by its publication date and time, but individuals desire to consume content at their own convenience. Hence, there is a need for asynchronous social consumption with thematic information solicited, curated, and customizable to enhance the enjoyment of a specific experience, while also enabling an individual to time-shift their consumption of the thematic information to their unique desire.

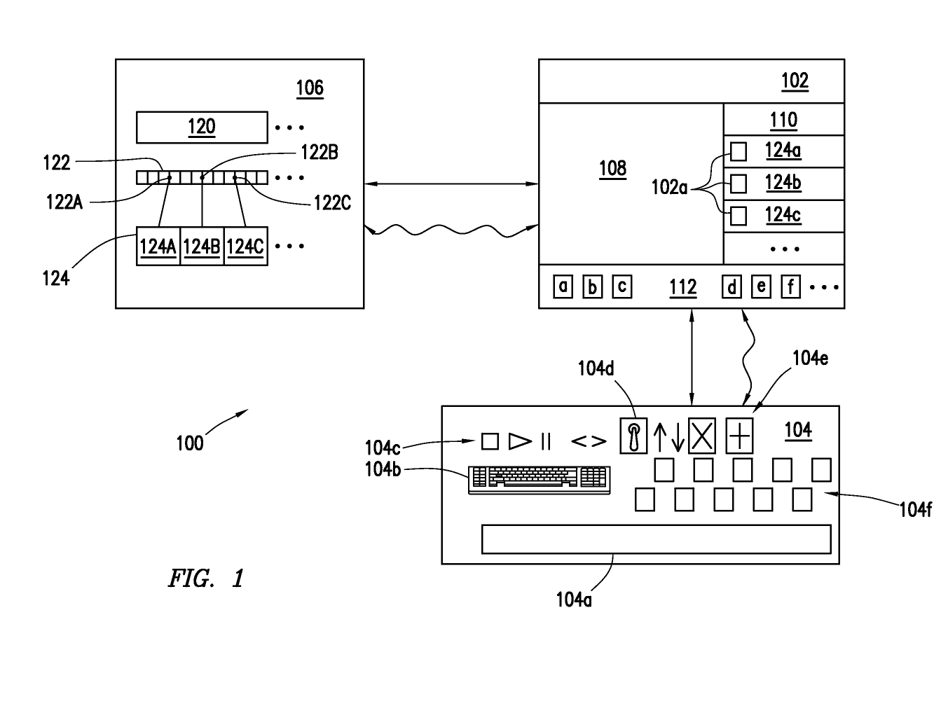

FIG. 1 is a schematic of an exemplary system according to the disclosure showing data flow to and from an exemplary display. A computerized system, generally designated 100, includes a display 102, a user input device 104, and a content database 106.

### Input Device

The user input device can be a keyboard, mouse, touch screen, voice activated controller, remote control, or other such device as is known in the art. In the case of a touch screen, the display and input device may merge. Generally, the input device 104 controls the content seen on the display 102. The same or a separate user input device can allow the user to input data to the system which can be displayed and stored.

### Display

The display 102 can be a television screen, mobile device screen, computer screen, tablet screen, or any other electronic screen capable of displaying audio, video, and audio-visual content and connected or connectable to a database 106, by wire or wirelessly.

An exemplary display is seen in FIG. 1, having a portions of the display dedicated to viewing Primary Content 108 and Secondary Content 110. The display can also feature Control Prompts 112 and additional features as explained below.

### Primary Content

Primary Content is previously recorded and transmitted entertainment data. Such data includes, for example, movies, television or cable programs, videos, concert and music videos, music, audio books, applications, sporting events, or other recorded live events. The Primary Content is viewed asynchronously to one or more initial transmissions, broadcasts airings, etc. That is, the Primary Content has already been viewed or experienced by the public prior to consumption by the user. The primary content data 120 can be created, stored, and transmitted using various formats and protocols, translated to further formats and protocols as necessary, and can be made available for asynchronous viewing by separate platforms and in various formats. Primary Content data can include audio, visual, audio-visual, and textual information.

### Secondary Content

The display 102 also simultaneously shows Secondary Content 110. The Secondary Content 110 is created after or concurrently with a transmission of the Primary Content 108. The user views the Secondary Content asynchronously to one or more initial transmissions, broadcasts, postings, airings, etc. That is, the Secondary Content has already been created, transmitted, viewed and experienced by the public prior to viewing by the user on the display. The Secondary Content data 124 is curated, sequenced, correlated to Primary Content data, and stored on a database. Generally, the Secondary Content data consists of “social media” regardless of how it was transmitted, re-transmitted, collected, solicited, or via what platform it was transmitted or posted. For example, social content can be presented from initial data collection and transmission platforms, such as Twitter®, Facebook®, Instagram®, Tumblr® or other commercial platforms, or can be collected from generally accessible public websites having publicly posted comments and other items. The Secondary Content data can be textual, audio, visual, and audio-visual media, such as, for example, texts, SMS messages, photos, images, programs, and documents (in various formats, such as gif, jpeg, png, mpeg, etc.). The Secondary Content can also be “scripts” created by third-party providers and supplied for the purpose of simultaneous viewing with selected Primary Content.

The Secondary Content also contains corresponding information components, such as content source (e.g., Name), type (e.g., photo, text, video, etc.), classification (e.g., comment, joke, fact, etc.), date and time of content posting, ratings of the content, ratings of the content source, etc.

Further, the Secondary Content can be correlated with a private Group, that is, a group of members comprising other users or contributors. Such a feature allows the user to see displayed Secondary Content created or transmitted by other persons in the Group. For example, the members of a Group can transmit Secondary Content about a selected Primary Content (e.g., a movie, show, event). When the Group Secondary Content is selected for viewing, the Secondary Content of the Group members is displayed to the user. The user can also submit Secondary Content with viewing limited to only Group members. The ability to add content to the Group Secondary Content can be limited to only Group members.

### Control Prompts

The display 102 and input device 104 can, singly, or jointly, show visual Control Prompts to assist in operating display and content control features. Control Prompts 112a-c can be seen on display 102 along with the Primary and Secondary Content, 108 and 110, and preferably can be reduced, hidden, or accessed by scroll-over, remote control transmission, touch, or other input from the User Input Device. Control Prompts 112a-c can include controls for the Primary Content 108 such as play, pause, stop, forward, backward, zoom, reduce display window, etc. Control Prompts can also include various mechanisms to control audio, video, or audio-visual synchronization between Primary and Secondary Content. Similar Control Prompts 112 can be provided for controlling the Secondary Content 110. Further Control Prompts and functionality for the Secondary Content can be provided as explained elsewhere herein.

Further, the display 102 can show or provide hyperlinks, tabs, icons, text, or other visual identifiers 112d-f providing additional information about the Primary and Secondary Content and access to further information or control functions. For example, the display can include a running timer for the Primary or Secondary Content, time and date stamps, etc.

### Content Input

The display 102 or Input Device 104 can also provide controls, prompts, and displays for inputting content and of user content previously input. For example, in one embodiment, a user can post or transmit user-created or selected Input Content, preferably related or in response to the Primary or Secondary Content. Such Input Content can include text, audio, visual, or audio-visual media, subjective ratings of the Primary and Secondary Content or their sources. The user can designate which other consumers can view the user's Input Content (e.g., public at large, Groups, etc.).

For example, the display 102 and one or more Input Devices 104 can contain a text box 104a, into which the user can input a text comment. An Input Device 104 can allow input of the text using, for example, a real or virtual keyboard 104b, real or virtual button array 104c, voice recognition input 104d, input and other icons 104f, etc. The display 102 or Input Device 104 can also contain rating icons 102a (e.g., +/−, thumbs up/down, multiple stars, etc.) related to displayed content or sources. Similarly, such ratings can be input by the user with the Input Device 104. Additionally, the display 102 or Input Device 104 can provide icons or prompts 104c for controlling display of Secondary Content, such as selecting or blocking from view or transmission particular sources of content (e.g., comments by particular secondary contributors, by contributors having selected ratings or volume of contributions, etc.), types of content (e.g., video, images, etc.), volume and rate of content (e.g., number of comments or responses to comments displayed simultaneously, duration of display of Secondary Content), levels or layers of content (e.g., responses to or discussion strings re: Secondary Content), classifications of content (e.g., music, quotations, jokes, etc.).

### Database

The Primary and Secondary Content data 120 and 124 is stored temporarily or permanently on a database 106 for transmission to a user network component and display 102. The database can be one or more computer drives, memory devices, servers, or applications. The database can be remote or local. The data on the database can be resident on one or multiple databases, transmitted to and from multiple databases, and can be downloaded, streamed, or otherwise transmitted, by wire or wirelessly, to the user's network and display 102. For example, the database 102 can be on a Content or Provider Server located distantly and accessed via the internet. The content can be streamed or downloaded to a local computer for display.

The database can be secured and accessed through security protocols (e.g., user name, password, virtual badge or tag, etc.). The database or connected databases can further store, manage, and administer user accounts including user preferences, identification, billing information, use history, account information, etc.

### Curating, Sequencing, Triggers

The Primary Content data 120 is stored on the database. Triggers 122, also stored on the database, are correlated to the Primary Content data. The triggers can be embedded in the Primary Content data or can be stored separately and correlated to the Primary Content data prior to, concurrent with, or after transmission of the Primary Content data from the database. The triggers are further correlated to selected stored Secondary Content data 124. The triggers can employ video, audio, image, text, geo-location or proximity of the user to a place, wireless communications, user prompts, or other means. Such triggers ensure the curated and sequenced Secondary Content data is displayed to the user at appropriate times and for appropriate intervals to enhance their interactive experience.

The triggers 122 are correlated to stored items of Secondary Content data 124A-C. For example, if the Primary Content data 120 is a video having a running time, the triggers can be correlated to designated times of the video. As a trigger is activated at a designated time, correlated Secondary Content data 124A-C is provided as displayed Secondary Content 124a-c on display 102. For example, at a running time t₁ of the Primary Content, a trigger 122A causes the display of Secondary Content data 124A at Secondary Content displays 124a; at a later running time t₂, a trigger 122B causes the display of Secondary Content 124B at 124b; etc. Triggers can also be correlated by or to prompts by the user Input Device 104. Further in an embodiment, the triggers can be selected or de-selected by the user according to trigger type, source, rating, date, etc.

Further, triggers can be automatically created in response to the occurrence of predetermined events in the Primary Content. For example, software can automatically create a trigger to display an item of Secondary Content corresponding to selected events detected in the Primary Content (e.g., gunshot, scream, car chase, applause, etc.).

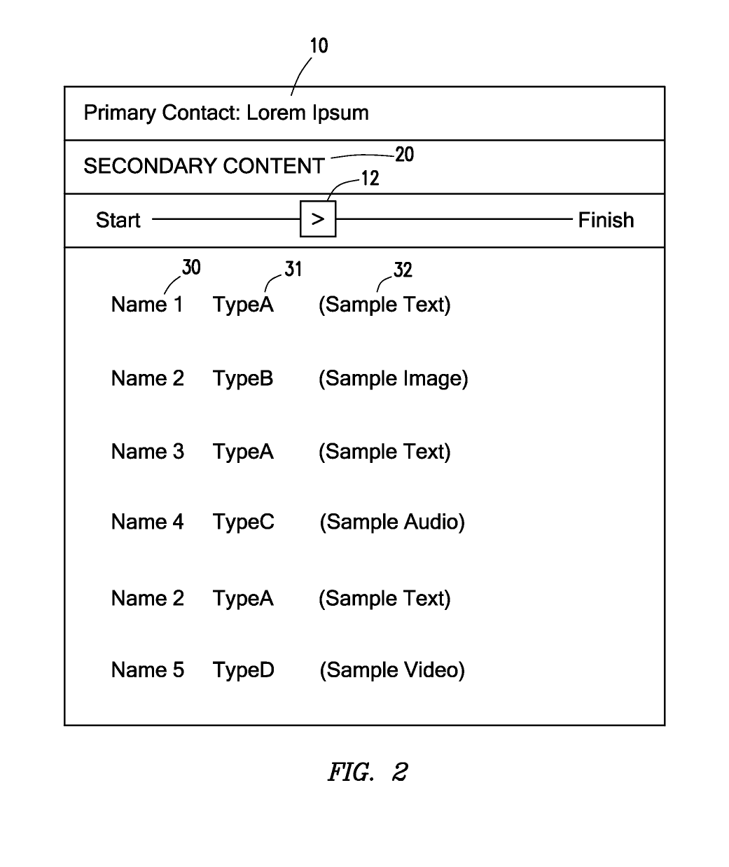

FIG. 2 is an exemplary display of Primary and Secondary Content according to aspects of the disclosure. The display includes information regarding the Primary Content 10, such as title, source, date of release, etc. Secondary Content 20 is displayed, including, for example, information about the Secondary Content such as source or contributor 30, classification 31, and the item of Secondary Content 32.

While experiencing Primary Content at any time asynchronous to the initial transmission of the content, an individual simultaneously accesses and sees Secondary Content and related information. Curated and sequenced Secondary Content is presented to the individual to coincide with and supplement their experience with the Primary Content. The display of each Secondary Content and related information, such as source 30, classification 31, and item 32, is triggered by identifiers in or correlated to the Primary Content. In one embodiment, a user can use a control prompts 12 to direct display of the Secondary Content irrespective of the triggers. This Secondary Content and its control are intended to enhance the experience of a user's interaction with the Primary Content, without requirement as to when or how the Primary Content is accessed.

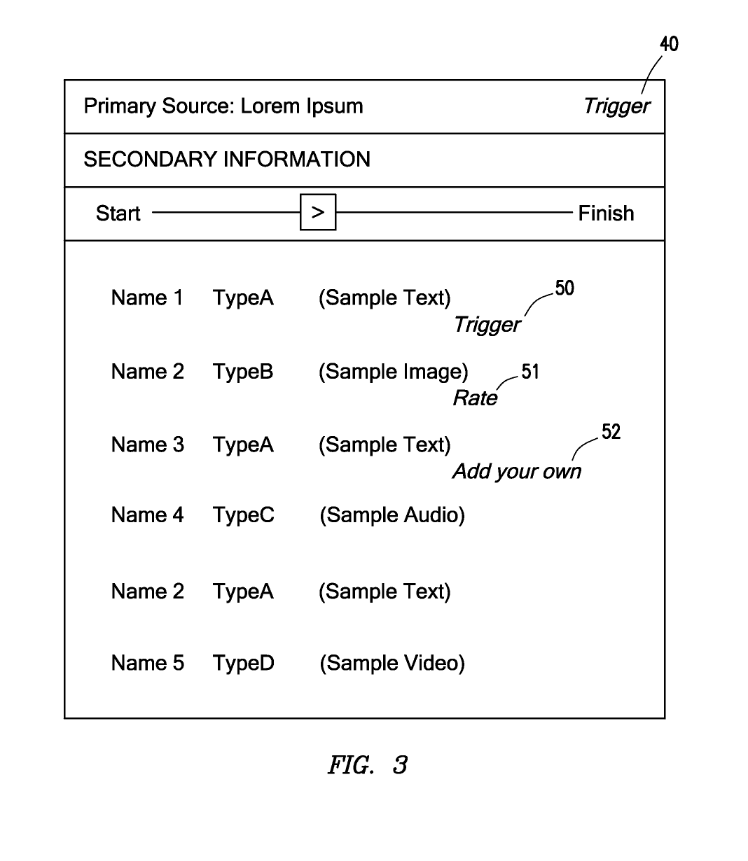

FIG. 3 is an exemplary display of Primary and Secondary Content, and User Content Input prompts according to aspects of the disclosure. The trigger 40 correlates the Secondary Content to the Primary Content or occurrences therein. The triggers can use video, audio, image, text, proximity, wireless communication, or other means, including optional content embedded within the Primary Content. Such a trigger ensures the curated and sequenced Secondary Content is presented to the user at appropriate times to enhance their interactive experience.

The user Input Prompts, such as classify 50, rate 51, and “add your own” 52, enable the user to input their own secondary content. The classification 51 prompt allows user cataloging of specific items of Secondary Content. The rate 51 prompt enables a user to assess perceived utility for items of Secondary Content. Though not explicitly illustrated here, such prompts and features are possible for all aspects of the Secondary Content. The “add your own” 52 prompt enables a user to supplement the curated and sequenced Secondary Content and make it available to other users. Through these features, the utility of the Secondary Content increases for any individuals interacting with the Primary and Secondary Content, enhancing their experience.

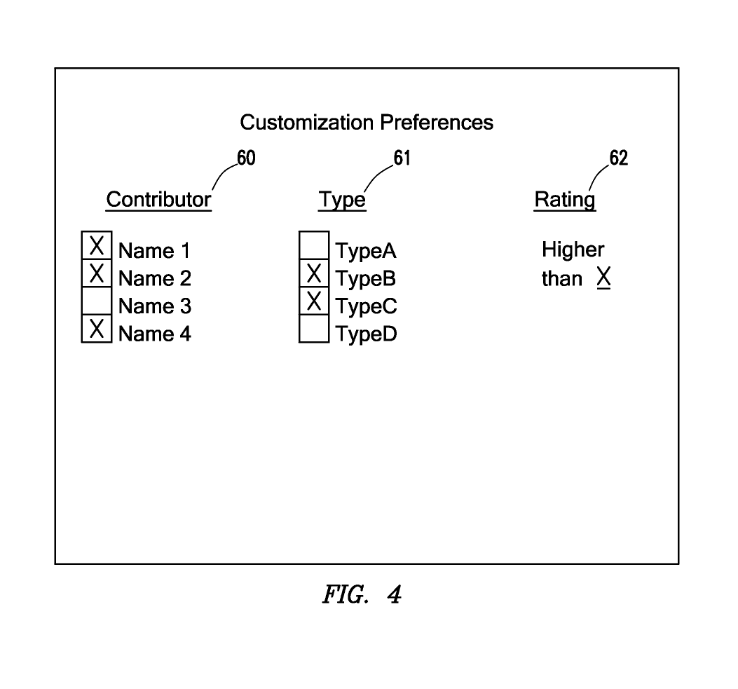

FIG. 4 is an exemplary display of Customization Preferences and prompts according to aspects of the disclosure. Through these preferences, a user can customize the curated and sequenced Secondary Content to their own desires. The Contributor 60 prompt represents an ability to filter information by source, the type 61 prompt represents an ability to filter information by classification, and the rating 62 prompt represents the ability to filter information by perceived utility as assessed by others. It is assumed that individual customization options for Secondary Content are not limited to these examples and may be extended to any specific element of available content or related information. Through customization, the specific Secondary Content displayed is controlled by the user, presenting a dynamic consumption experience to enhance the interaction with the content.

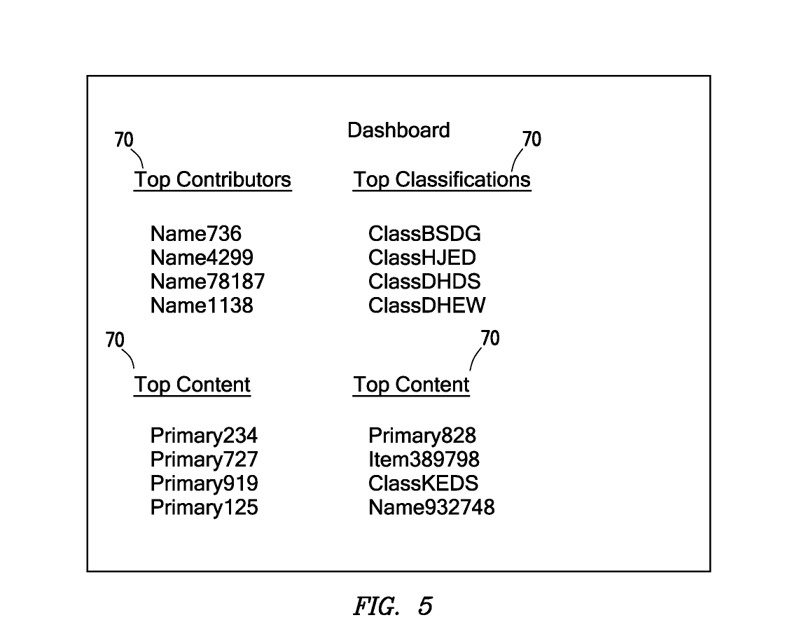

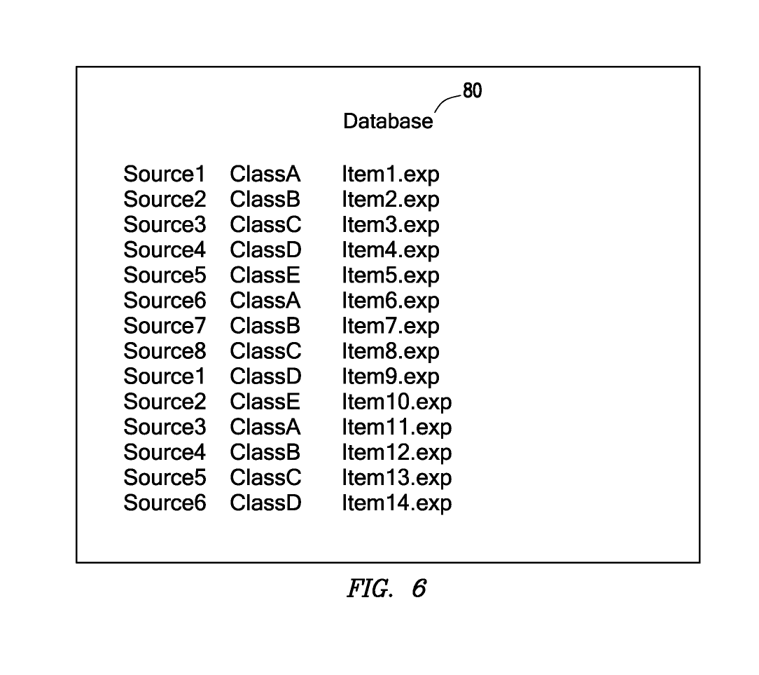

FIG. 5 is a schematic illustrating an aggregated view of activity related to the method of this disclosure. FIG. 6 is a schematic representation of a database and data stored therein according to an aspect of the disclosure. Presented data 70 may take the form of popular, recent, or otherwise noteworthy specific content. The database 80 stores the curated and sequenced data and related information. These are only examples, as the aggregated data 70 and database 80 will necessarily be far more involved that what is possible to represent here. The data, both in aggregated and disaggregated forms, enables a richer experience of the Secondary Content and related information, which, in turn, enables an enhanced experience with the Primary Content.

### System Architecture

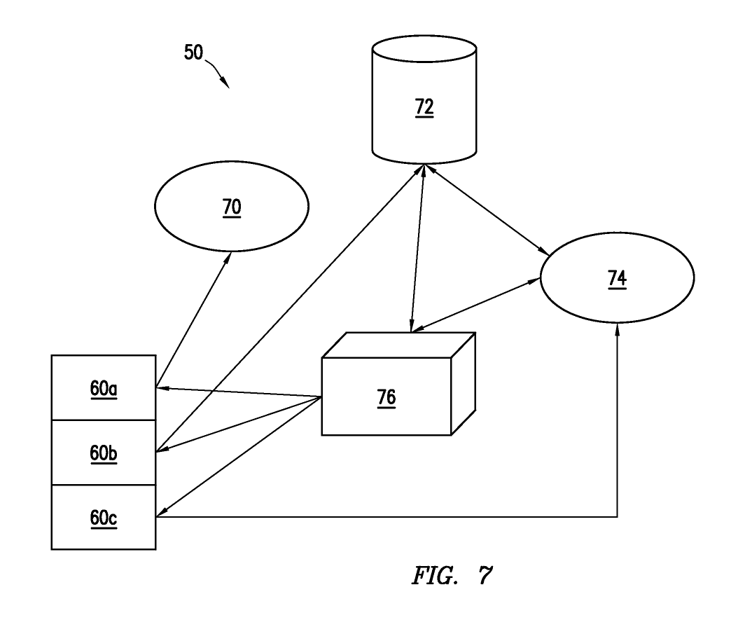

FIG. 7 is an exemplary computer network according to an aspect of the disclosure. The network 50 may have multiple components, including Hardware, Software, Databases, Personal Devices, etc. The illustrated network includes personal devices 60, an administrative console 70, a content database 72, a user filter 74, and a presentation layer 76. The network need not include all of these exemplary devices and can include additional or substitute components. Communication between components can be by wire, wireless, infrared, radio frequency, Ethernet, or any other technology known or later developed.

The personal devices 60 access content from the presentation layer 76, contribute content to the content database 72, or contribute preferences to the user filter 74. Contributed content may or may not first be routed through an admin console 70 dependent upon the contribution or contributor.

Dependent upon time, location, user preference, and other potential variables conveyed through the personal devices 60, content from the content database 72 is compared to user filter 74 information before being passed on to the presentation layer 76 for consumption on personal devices 60.

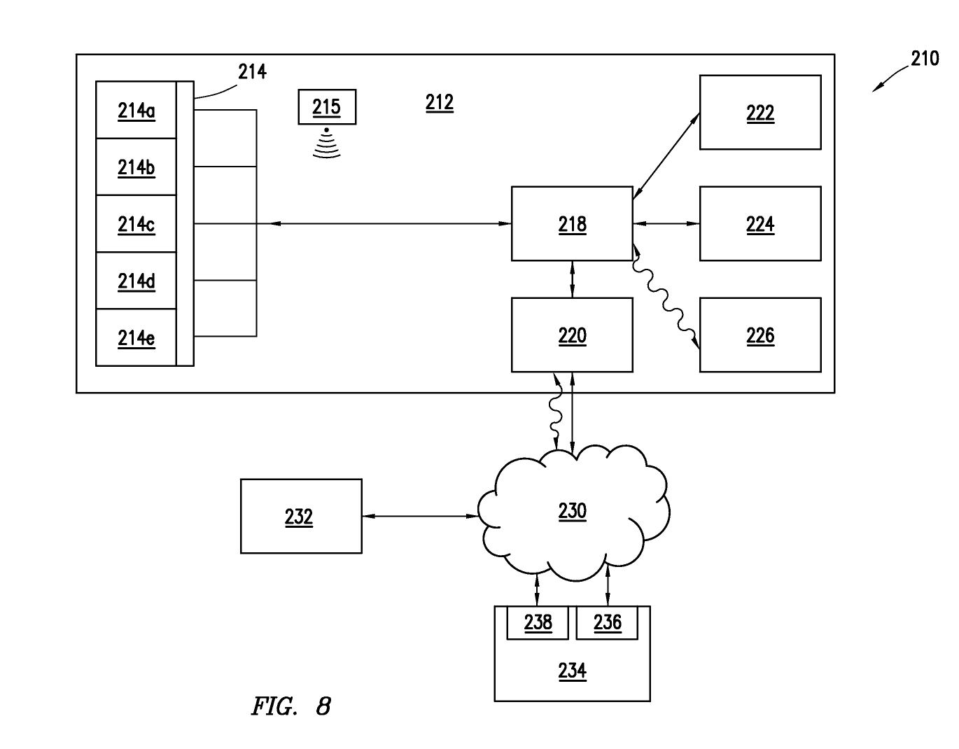

FIG. 8 is a schematic of an exemplary computerized architecture according to an aspect of the disclosure. A premises 210, such as a house, business, etc., has a remote private network 212. The network 212 will be referred to as a private network to distinguish it from the internet and other public networks, although the private network can have multiple authorized users. A user can be multi-tenant or have multiple systems controlled on one user account. Further, to indicate its installation and maintenance independent of the provider and administrator networks, the network 212 is referred to as remote. The remote private network can also be thought of and referred to as a user network.

The remote private network 212 can have multiple components, including hardware, software, appliances, etc. The illustrated private network 212 includes a display 214 having multiple, manipulable, and optionally shown display windows 214a-e, a control gateway 218, an IP addressable router 220, a personal computer 222, laptop or notebook 224, and a mobile phone (or other mobile device) 226. The private network need not include all these exemplary devices and can include additional or substitute devices. Communication between the components of the private network is by wire or wireless, infrared, RF, Ethernet, or any other technology known or later developed.

The display 214 can be a television screen, computer screen, touch screen, mobile device screen, tablet screen, etc. The display windows 214a-e are capable of manipulation by the user, such as maximizing, minimizing, zoom, re-arrangement, open/close, etc. The windows 214 include at least a Primary Content window 214a, and a Secondary Content window 214b for simultaneous display. Although the display 214 is shown physically separate from the various remote network components, it is understood that the display can be integral to a component.

One or more of the private network components 218, 220, 222, 224, and 226, can be used as or have an integral user input device. Alternately, a separate input device 215 can be provided for controlling the display, such as a remote control with dedicated buttons, a remote control with touch screen and menus, etc. The input device 215 can operate the screen 214 directly or via the network components 218, 220, 222, 224, and 226. The input device 215 can be considered a network component.

A router 220 provides connectivity with the internet 230 by wire or wirelessly. The internet, World Wide Web, and cloud are understood by those of skill in the art and are terms of art, and will not be described in detail herein.

In one embodiment, a gateway 218 provides connectivity, via the internet, to a purposed content server 234. The gateway 218 can be a stand-alone appliance, such as a hand-held or wall-mounted controller, or can be an application or software supplied and accessible from another computer, such as personal computer 222, mobile device 226, notebook 224, etc. The gateway can have the “look and feel” of an application, web page, browser, server interface, etc. The gateway can be operated or controlled by gateway software providing computer executable instructions to the hosting computer or network that, when executed, connects a computer of the remote private network to the content server. Initially and periodically, gateway software can be uploaded to the private network.

The content server 234 can be an actual or virtual server, multiple servers, and can include further hardware, software, and networked devices. The content server 234 can be partitioned, aggregated, etc., as is known in the art. The content server includes both stored data and programs, such as provider content or gateway software, and serves as a content administrator for controlling access to and transmission of data from the content server. The content server is web-hosted or internet-hosted and accessed via the internet. The content server can be connected to or accessed through a web page, via an internet browser or application, etc.

A remote provider network 232 has connectivity to the content server 234, again, via the internet. The provider network can include servers (actual or virtual), and other hardware and software, as well as other network devices. The remote provider network is independent from the content server 234 and the private network 212. The remote provider network stores and manages provider content, such as software programs for controlling and displaying primary, secondary and provider content. The content made available by the provider network can be software, streaming content, calendaring software or data, activation software or data, use-management software or data, interface or protocol software, software or data for synchronization of primary, secondary, and provider content, software or data for synchronizing content across multiple users or private networks, subscription software or data, and any combination thereof. The provider content transmitted from the content server to the remote private network, upon execution, controls one or more of the display 214, and private network components 215, 218, 220, 222, 224, and 226.

Provider content can include text, audio, visual, audio-visual, or other types of content, and can correspond to various selections of Primary Content or Secondary Content. For example, a Provider can supply Secondary content corresponding to selected Primary Content, such as miming commentary (via updated display of Secondary Content) corresponding to a running movie or program. Alternately, the Provider Content can include tutorial, instructional, or educational items (text, photo, etc.) corresponding to the running Primary Content. A Provider can then offer subscriptions (free or at a cost) to users for their content corresponding to multiple Primary Content items.

The content server 234 transmits (e.g., pushes, uploads, etc.) provider content to the user or private network. Conversely, the private network can download or pull content from the server. Similarly, the provider network 232 transmits input content to the content server 234. Conversely, the content server downloads or pulls content from the provider network.

The content server 234 preferably acts as an administrator by controlling access to the server, available content to the user, etc. The content server stores, sequences, accesses, controls, monitors, and tracks content, and/or provides accounting, logging, and other management functions. The content server can also be employed to maintain individual user accounts 236, for example, on a user account server, corresponding to a user's remote private network. The user account server can be real or virtual and can reside on or be controlled by the content server. Similarly, the content server can be employed to maintain individual provider accounts 238, for example, on a provider account server, corresponding to a plurality of remote provider networks. The provider account server can be real or virtual and can reside on or be controlled by the content server.

The content server 234 or associated servers (e.g., user account server, provider account server) can administer access by a user of a remote private network to content on the server. For example, such administration can include identifying and verifying the user of a remote private or provider network before allowing access to the content server. Identification and verification can include cross-indexing IP addresses, requiring user name and password, etc., as is known in the art.

Further, administration can include collecting individual user data corresponding to a remote private network. Administering access by a user of a remote private network can include collecting, storing, and associating user data with the corresponding user account. Individual user data can include user name, user password, user IP address, user physical address, user component data, calendaring data, subscription data, or permissions for real-time control by a subscription administrator. User data can also include selection of content; selection of subscription services for control content; selection of authorized administrators having access to the user's private network; selection of times authorized administrators have access to the user's private network; identification of the number, type, specifications, and location of network components and displays at the user's premises; and any combination thereof. The server can transmit to the private network executable software.

The content server and administrator can also administer transmission of provider content from a provider network directly to the remote private network, including identifying and verifying the remote provider network and the remote private network, and transmitting data regarding the verification to at least one of the remote provider network and remote private network.

### Method

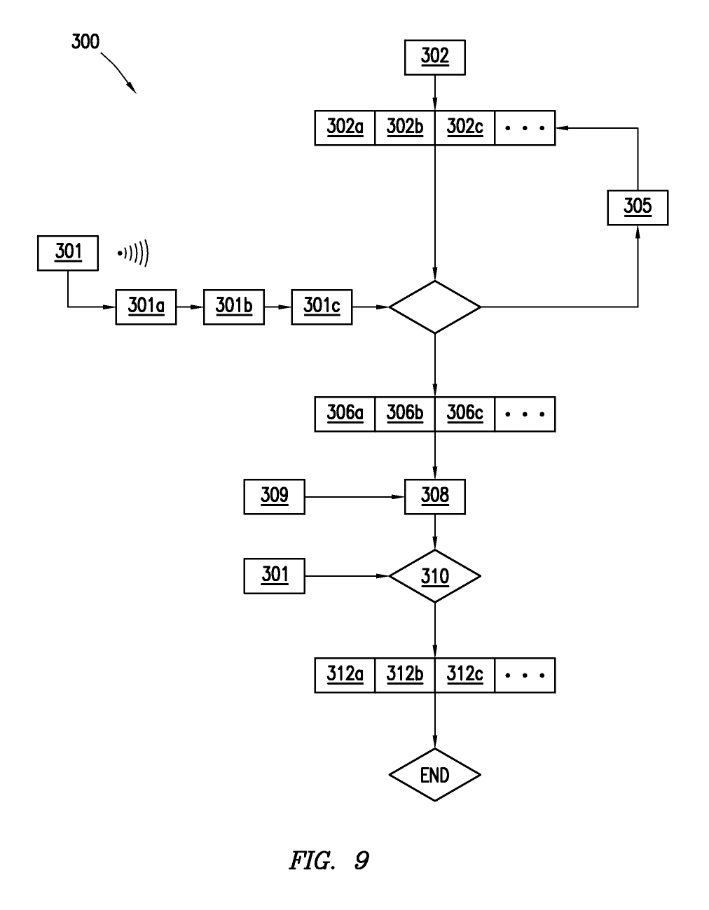

FIG. 9 is a flow chart according to an aspect of the invention. FIG. 9 provides a flow chart, algorithm, or decision tree for a software program, generally designated 300, whether resident on the private network, provider network, content server, or a combination thereof, is activated. At step 302 the software causes an introductory or Home window to appear on one or more user displays. The Home display can include any number of visual prompts providing the user access to various content, content information, or device controls. At step 304, a plurality of Primary Content prompts 304a-c . . . are made to appear on a user display. The prompts can be grouped, accessed via tab or other icon, rotated or otherwise displayed in response to user input. That is, not all of the prompts need appear simultaneously on the display.

A user input device 301 is utilized throughout the method. The user input device can be of various type and functionality as described elsewhere herein. The software receives one or more user inputs 301a-c . . . . This input, guided by the prompts 304, directs the software to take any of a plurality of additional steps 306. For example, the input can indicate selection (or de-selection) of Primary Content and Secondary Content, related information components (source, type, classification, time, ratings, etc.), display controls (window selection and arrangement, zoom, synch, etc.), component controls (volume, play, stop, etc.), and user content input (add comment, upload photo or video, etc.). Further, the prompts can refer to specific commercial platforms for social media, as described elsewhere, providing access to such platforms and their functionality The software, in response to user selections, can provide additional prompts, such as via drop-down menus, text box, check lists, etc. Additional inputs can be solicited multiple times 305 as needed until appropriate inputs are acquired to indicate a specific action to take. For example, the software may display selections of a Primary Content by theme, date, type, etc., followed by displaying selected Primary Content by title, with additional displaying of further selections (content format, display preferences, etc.). The process can be repeated at 305 for Secondary Content and related information.

Upon receiving adequate the user inputs 301a-c . . . to indicate a required action, the software takes a related action 306. For example, the actions 306a-c . . . can include connecting to local, content, and provider servers, transmitting data to and receiving data from such servers (such as content selections, access to accounts, payment authorization, etc.), streaming or playing content, synchronizing content, etc.

Once content is being displayed, the software will continue to update 308 the displayed windows and content. For example, updated Secondary Content is displayed at the prompting of triggers 309 embedded in the Primary Content, provided or retrieved from a content or other server, manually entered, etc. During viewing, the user can continue to provide user input at 310. This user input can be any of the various controls, information components, etc., discussed herein. The software receives the input 310 and takes appropriate action at step 312a-c . . . . Appropriate actions can include stopping, pausing, fast forwarding, etc., of Primary or Secondary Content, adding or changing ratings, types, classifications, etc., providing prompts to solicit user Input Content (text box, upload prompts, etc.), and other actions discussed herein.

It is also possible to have real-time updates of Secondary Content. For example, where a private Group has been selected for Secondary Content, group members, each viewing the Primary and Secondary Content at separate locations, can add content which is then displayed in real-time on the displays of each participating group member. The software determines whether requested content requires real time administration. If real-time administration is required, the private network is connected to the content or other server, which administers access. A connection is made to the server(s) hosting the real-time content and the content is streamed, periodically transmitted, etc.

### Method Support

The following disclosure is provided in support of the methods claimed or which may be later claimed. Specifically, this support is provided to meet the technical, procedural, or substantive requirements of certain examining offices. It is expressly understood that the portions or actions of the methods can be performed in any order, unless specified or otherwise necessary, that each portion of the method can be repeated, performed in orders other than those presented, that additional actions can be performed between the enumerated actions, and that, unless stated otherwise, actions can be omitted or moved. Those of skill in the art will recognize the various possible combinations and permutations of actions performable in the methods disclosed herein without an explicit listing of every possible such combination or permutation. It is explicitly disclosed and understood that the actions disclosed, both herein below and throughout, can be performed in any order (xyz, xzy, yxz, yzx, etc.) without the wasteful and tedious inclusion of writing out every such order.

Support for the claimed methods and steps of methods is provided here. It is explicitly understood that each of the steps can be performed in any order, repeated, omitted, performed before or after additional steps, named and unnamed, etc., unless stated otherwise. The descriptions of the methods are provided with numerical references which are to be considered no more than references for convenience. An exemplary method 1. of providing asynchronous media content for consumption by a user, the method comprising: displaying previously publicly-transmitted Primary Content on a display; simultaneously displaying previously publicly-transmitted Secondary Content on the display; updating the Secondary Content on the display over time; and correlating the displaying of the Secondary Content and the Primary Content. 2. The method of claim 1, further comprising receiving transmission of and storing user content in response to an input device. 3. The method of claim 1, further comprising storing Primary Content data and Secondary Content data on a memory storage device. 4. The method of claim 3, further comprising storing triggers correlated to the Primary Content data. 5. The method of claim 4, wherein updating of the Secondary Content is in response to a trigger. 6. The method of claim 4, wherein the triggers are embedded in the Primary Content data. 7. The method of claim 1, further comprising receiving user input for controlling the displaying of Primary or Secondary Content. 8. The method of claim 1, wherein the Primary Content is selected from the group consisting of: movies, television or cable programs, videos, concert and music videos, music, audio books, applications, sporting events, and other recorded events. 9. The method of claim 1, wherein the Secondary Content is selected from the group consisting of: social media, textual media, audio media, visual media, audio-visual media, texts, SMS messages, photos, images, programs, and documents. 10. The method of claim 7, further comprising changing the displayed Primary Content or Secondary Content in response to a user input. An exemplary method 11. of providing asynchronous viewing of media content to users, comprising: connecting one or more content servers to the internet, the content servers having stored thereon Primary Content data and Secondary Content data; connecting a private network located at a premises, via the internet, to the one or more content servers; transmitting Primary Content data and correlated Secondary Content data for simultaneous viewing on a display at the premises. 12. The method of claim 11, wherein the Primary Content data and Secondary Content data are resident on the same server. 13. The method of claim 11, wherein the private network comprises at least two of the following network components: laptop computer, desktop computer, server, mobile device, tablet, cable box, television, remote controller, and gateway. 14. The method of claim 11, wherein the Primary Content data is selected from the group consisting of: movies, television or cable programs, videos, concert and music videos, music, audio books, applications, sporting events, and other recorded events; and wherein the Secondary Content data is selected from the group consisting of: social media, textual media, audio media, visual media, audio-visual media, texts, SMS messages, photos, images, programs, and documents. 15. The method of claim 11, wherein the one or more content servers further have trigger data stored thereon, the trigger data correlating the Primary and Secondary Content data. 16. The method of claim 11, further comprising: connecting, via the internet, a remote provider network to the content server or private network; and transmitting Primary Content data and Secondary Content data from the provider network to the content server or facilitating transmission of such data to the private network. 17. The method of claim 11, further comprising at least one of: maintaining individual user accounts on a user account server corresponding to a plurality of private networks; administering access by private networks to Primary and Secondary Content on the content server; maintaining individual provider accounts, on a provider account server, corresponding to a plurality of provider networks; and administering access of a provider network to the content server. 18. The method of claim 11, wherein transmitting Primary Content data and correlated Secondary Content data for simultaneous viewing on a display at the premises comprises streaming data for display or uploading data to the private network. 19. The method of claim 17, wherein administering access by a user of a private network further comprises collecting, storing, and associating user data with the corresponding user account.

### Conclusion

The indefinite articles “a” or “an” can mean one or more than one of the component, part, or step that the article introduces. The terms “and,” “or,” and “and/or” shall be read in the least restrictive sense possible.

While the foregoing written description of the disclosure enables one of ordinary skill to make and use the embodiments discussed, those of ordinary skill will understand and appreciate the existence of variations, combinations, and equivalents of the specific embodiments, methods, and examples herein. The invention should therefore not be limited by the above described embodiments, methods, and examples. While this disclosure has been described with reference to illustrative embodiments, this description is not intended to be construed in a limiting sense. Various modifications and combinations of the illustrative embodiments as well as other embodiments of the invention will be apparent to persons skilled in the art upon reference to the description. It is, therefore, intended that the appended claims encompass any such modifications or embodiments. The particular embodiments disclosed above are illustrative only, as the present disclosure may be modified and practiced in different but equivalent manners apparent to those skilled in the art having the benefit of the teachings herein. It is, therefore, evident that the particular illustrative embodiments disclosed above may be altered or modified and all such variations are considered within the scope of the present disclosure. The various elements or steps according to the disclosed elements or steps can be combined advantageously or practiced together in various combinations or sub-combinations of elements or sequences of steps to increase the efficiency and benefits that can be obtained from the disclosure. It will be appreciated that one or more of the above embodiments may be combined with one or more of the other embodiments, unless explicitly stated otherwise. The disclosure illustratively disclosed herein suitably may be practiced in the absence of any element or step that is not specifically disclosed or claimed. Furthermore, no limitations are intended to the details of construction, composition, design, or steps herein shown, other than as described in the claims.

It is claimed:

1. A method of providing asynchronous media content for consumption by a user, the method comprising:
displaying previously publicly-transmitted Primary Content on a display;
simultaneously displaying previously publicly-transmitted Secondary Content on the display;
updating the Secondary Content on the display over time; and
correlating the displaying of the Secondary Content and the Primary Content.

2. The method of claim 1, further comprising receiving transmission of and storing user content in response to an input device.

3. The method of claim 1, further comprising storing Primary Content data and Secondary Content data on a memory storage device.

4. The method of claim 3, further comprising storing triggers correlated to the Primary Content data.

5. The method of claim 4, wherein updating of the Secondary Content is in response to a trigger.

6. The method of claim 4, wherein the triggers are embedded in the Primary Content data.

7. The method of claim 1, further comprising receiving user input for controlling the displaying of Primary or Secondary Content.

8. The method of claim 1, wherein the Primary Content is selected from the group consisting of: movies, television or cable programs, videos, concert and music videos, music, audio books, applications, sporting events, and other recorded events.

9. The method of claim 1, wherein the Secondary Content is selected from the group consisting of: social media, textual media, audio media, visual media, audio-visual media, texts, SMS messages, photos, images, programs, and documents.

10. The method of claim 7, further comprising changing the displayed Primary Content or Secondary Content in response to a user input.

11. A method of providing asynchronous viewing of media content to users, comprising:
connecting one or more content servers to the internet, the content servers having stored thereon Primary Content data and Secondary Content data;
connecting a private network located at a premises, via the internet, to the one or more content servers;
transmitting Primary Content data and correlated Secondary Content data for simultaneous viewing on a display at the premises.

12. The method of claim 11, wherein the Primary Content data and Secondary Content data are resident on the same server.

13. The method of claim 11, wherein the private network comprises at least two of the following network components: laptop computer, desktop computer, server, mobile device, tablet, cable box, television, remote controller, and gateway.

14. The method of claim 11, wherein the Primary Content data is selected from the group consisting of: movies, television or cable programs, videos, concert and music videos, music, audio books, applications, sporting events, and other recorded events; and wherein the Secondary Content data is selected from the group consisting of: social media, textual media, audio media, visual media, audio-visual media, texts, SMS messages, photos, images, programs, and documents.

15. The method of claim 11, wherein the one or more content servers further have trigger data stored thereon, the trigger data correlating the Primary and Secondary Content data.

16. The method of claim 11, further comprising: connecting, via the internet, a remote provider network to the content server or private network; and transmitting Primary Content data and Secondary Content data from the provider network to the content server or facilitating transmission of such data to the private network.

17. The method of claim 11, further comprising at least one of: maintaining individual user accounts on a user account server corresponding to a plurality of private networks;
administering access by private networks to Primary and Secondary Content on the content server; maintaining individual provider accounts, on a provider account server, corresponding to a plurality of provider networks; and administering access of a provider network to the content server.

18. The method of claim 11, wherein transmitting Primary Content data and correlated Secondary Content data for simultaneous viewing on a display at the premises comprises streaming data for display or uploading data to the private network.

19. The method of claim 17, wherein administering access by a user of a private network further comprises collecting, storing, and associating user data with the corresponding user account.
